(19) United States
(12) Patent Application Publication
(10) Pub. No.: US 2024/0215618 A1
(43) Pub. Date: Jul. 4, 2024

(54) STEAM OVEN

(71) Applicant: Raja Singh Tuli, Montreal (CA)

(72) Inventor: Raja Singh Tuli, Montreal (CA)

(21) Appl. No.: 18/403,962

(22) Filed: Jan. 4, 2024

Related U.S. Application Data
(60) Provisional application No. 63/437,069, filed on Jan. 4, 2023.
(60) Provisional application No. 63/454,768, filed on Mar. 27, 2023.

(51) Int. Cl. A23L 5/10; A23L 3/365; A47J 27/04; G06V 20/64; G06V 20/68

(52) U.S. Cl. CPC A23L 5/13; A23L 3/365; A23L 5/17; A47J 27/04; G06V 20/64; G06V 20/68; A47J 2027/043

(57) ABSTRACT

The present invention provides an apparatus and a method for cooking the foodstuff in a pressurized steam oven with the foodstuff being steam cooked in the first stage and seared in the next stage. The method automatically identifies the time of the first stage (slow) cooking and the time of the second stage (fast) cooking based on the type, size, temperature, and 3D image of the foodstuff. The slow cook is stopped before the foodstuff reaches the critical temperature by an amount determined by various parameters and next, the fast cook of searing is started. The slow cook method can be a pressurized steam cooking method. The method automatically reduces the time of the slow cooking so that the internal temperature of the food does not prematurely reach the critical temperature. The method helps in avoiding overcooking the foodstuff during the searing stage.

### CROSS-REFERENCE TO RELATED APPLICATIONS

This application claims priority to U.S. provisional patent application Nos. 63/437,069, entitled “STEAM OVEN,” filed on Jan. 4, 2023 and 63/454,768, entitled “STEAM OVEN,” filed on Mar. 27, 2023. The content of these U.S. provisional patent applications are hereby incorporated by reference in their entireties for all purposes.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The present disclosure generally relates to the field of cooking foodstuffs such as meats and vegetables, in a faster, more efficient manner. More particularly, the invention relates to a method and apparatus for cooking the foodstuff in a pressurized steam oven with the foodstuff being steam cooked in a first stage and seared in a second stage. The invention also relates to the technical field of cooking appliances, in particular to a steam oven control method and device, cooking equipment, steam cooking, and searing all-in-one machine.

### Description of Related Art

Intelligent household appliances, such as steaming and baking ovens, have made life more convenient by providing a range of facilities. However, these appliances often have different settings for different brands and models, making it difficult for users without experience to correctly set the heating mode, temperature, and time for a particular food material. Even those with some experience may find it challenging to adjust the settings for different types of food. To produce delicious meals, it is important for users to understand the various heating modes, temperatures, and times for their specific oven and the food they are cooking. However, this can be complicated, particularly for those with limited cooking experience. If the parameters are set incorrectly, it can result in undercooked or overcooked food that must be discarded, leading to wasted food and energy. Improperly cooked food can also be a safety hazard, as undercooked food may contain harmful bacteria while overcooked food may be burnt and potentially cause injury. It is important for users to carefully set the appropriate parameters and monitor the cooking process to ensure that their food is cooked safely and properly.

While some ovens claim to determine if the food is cooked properly, the determination is purely based on the outer surface of the food. This can lead to inaccurate judgment, resulting in a poor user experience. For example, the surface of the food may appear to be cooked, but the inner part may still be raw. This can be a safety hazard, as undercooked food may contain harmful bacteria, and it can also be frustrating for the user who may have to discard the food and start over. To ensure that food is cooked properly, it is important for the oven to be able to identify the food material, and accurately assess the internal temperature of the food while cooking, not just the surface.

There are some methods that use image recognition technology to identify the type of food material and automatically cook it. However, these methods are limited in that they only identify the food material and initiate cooking, resulting in a poor automatic cooking experience for the user. To improve the automatic cooking experience, it would be helpful for the oven to be able to not only identify the type of food, but also adjust the cooking parameters based on the specific characteristics of the food, such as its size, shape, and desired level of doneness. This would allow for more precise and personalized cooking, resulting in a better overall user experience.

In the past, methods and devices have used compressed air (both preheated and not) to achieve browning and surface texture on cooked meat and have tried to control the relative humidity within an oven or pressure vessel. However, these known pressure cooking processes that use high-pressure steam tend to produce meat that looks and tastes boiled rather than roasted. This can be undesirable for those who prefer the taste and appearance of roasted meat. To achieve a roasted flavor and texture, it may be necessary to use additional cooking methods or techniques once high-pressure steam cooking step is complete.

Another problem with using high-pressure steam for cooking foodstuff is that it can lead to overcooking easily, particularly for thin cuts of meat like fish and chicken. In a restaurant setting, it is possible to sear the meat quickly using a very hot oven, which conserves energy and reduces cooking time. However, this is not always possible at home, where cuts of meat may be thinner and more delicate. As a result, it can be difficult to achieve the desired balance of juicy and crisp when cooking meat at home. To achieve a perfectly cooked piece of meat that is juicy on the inside and crisp on the outside, it may be necessary to control the time of the cooking steps better suited to the type and thickness of the foodstuff being cooked.

There is accordingly a need for an improved cooking apparatus and cooking process by providing more precise and evenly distributed heat, as well as better control over the cooking environment.

It is therefore an object of the present invention to provide a cooking apparatus for cooking foodstuffs such as meats and vegetables, in a faster, more efficient manner by producing a mixture of compressed air and superheated steam. Further, the invention relates to a method and apparatus for cooking the foodstuff in a pressurized steam oven cavity with the foodstuff being steam cooked in a first stage and seared in a second stage. The invention can improve the cooking process by providing more precise and evenly distributed heat, as well as better control over the cooking environment. It may also be more energy efficient and easier to use compared to traditional cooking methods.

### SUMMARY OF THE INVENTION

The following summary is provided to introduce a selection of concepts in a simplified form that are further described below in the detailed description. This summary is not intended to identify key features or essential features of the claimed subject matter, nor is it intended to be used to limit the scope of the claimed subject matter.

The invention relates to cooking foodstuffs such as meats and vegetables, in a faster, more efficient manner. More particularly, the invention relates to a method and apparatus for cooking the foodstuff in a pressurized steam oven with the foodstuff being steam cooked in the first stage and seared in the next stage. The purpose of the present invention is to provide a faster and more efficient method of cooking food items while maintaining high product yield. Additionally, the invention can help in cooking and browning food items evenly in a single cycle.

In a preferred embodiment of the present invention, an apparatus and a method for cooking the foodstuff are disclosed. The foodstuff is steam cooked in the first stage and seared in the next stage. The method automatically identifies the time of the first stage (slow) cooking and the time of the second stage (fast) cooking based on the type, size, temperature, and 3D image of the foodstuff. In another embodiment of the invention, the method automatically identifies the time of the first stage (slow) cooking and the time of the second stage (fast) cooking based on the type, size, and internal temperature, the foodstuff. The slow cook is stopped before the foodstuff reaches to critical temperature by an amount determined by various parameters and next, the fast cook stage of searing is started. The slow cook method can be a pressurized steam cooking method. The method automatically reduces the time of the slow cooking so that the internal temperature of the food does not prematurely reach the critical temperature. The method so helps in avoiding overcooking the foodstuff during the searing stage.

In an alternate embodiment of the invention, a camera inside the cooking apparatus can identify the foodstuff like beef, chicken, fish etc. placed inside the cooking chamber. The cooking apparatus can download the properties of the foodstuff from a database available at the computing device, user mobile device etc. Based on the properties of the foodstuff, the cooking apparatus determines the first portion of the time of cook and reduce that time such that when the sear happens in the next stage of cooking, the critical temperature is achieved but not exceeded and foodstuff is not overcooked. A 3D profile of the foodstuff can be created using a 3D scanning means provided inside or outside of the cooking apparatus in various embodiments of the inventions. In another embodiment of the invention, 3D profile of the foodstuff can be created based on an image taken by the user of the foodstuff before putting the foodstuff into the cooking chamber.

In another embodiment of the invention, a thermometer inside the cooking chamber of the cooking apparatus continuously measures the internal temperature of the foodstuff. A rate of change of the internal temperature of the foodstuff can be calculated from the reading received from the thermometer. Based on the rate of change of the internal temperature of the foodstuff during the first cook period, the method can estimate an updated time for cooking the foodstuff in the first stage. The method can further predict the amount of time to be reduced for cooking the foodstuff in the first stage based on the rate of increase in the internal temperature of the foodstuff while cooking. In some embodiments, the method can reduce other parameters such as temperature, pressure or humidity etc. during the first cook period based on the rate of change of the internal temperature of the foodstuff. In another embodiment, other parameters such as, but not limited to, the initial temperature of the foodstuff, the current cooking temperature of the cooking apparatus and cooking pressure inside the cooking chamber of the cooking apparatus can also be used to predict the amount of time to be reduced for cooking the foodstuff in the first stage. Furthermore, the method can reduce the first portion of cooking time such that when the sear happens in the next stage of cooking, the critical temperature is achieved but not exceeded and the foodstuff is not overcooked.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1a is a perspective front view of an example cooking apparatus in accordance with the subject disclosure.

FIG. 1b is a perspective side view of an example cooking apparatus in accordance with the subject disclosure.

FIG. 2 illustrates an example networked system of a cooking apparatus according to some embodiments of the invention.

FIG. 3 is a flow diagram illustrating the operation of the cooking apparatus in accordance with the various embodiments.

FIG. 4 is a flow diagram illustrating the operation of the cooking apparatus in accordance with the various embodiments.

FIG. 5a is a time diagram in accordance with the preferred embodiment of the invention.

FIG. 5b is a time diagram in accordance with an alternate embodiment of the invention.

### DETAILED DESCRIPTION

The subject disclosure is directed to cooking foodstuffs such as meats and vegetables, in a faster, more efficient manner. More particularly, the invention relates to a method and apparatus for cooking the foodstuff in a pressurized steam oven with the foodstuff being steam cooked in the first stage and seared in the next stage.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

References to an “app”, an “application”, and a “software application” shall refer to a computer program or group of programs designed for end users. The terms shall encompass standalone applications, thin client applications, thick client applications, web-based applications, such as a browser, and other similar applications.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

In the preferred embodiment of the invention, the foodstuff comprises foods items such as meat (e.g., bacon, pork chops, sausage, hamburger patties), poultry (e.g., whole turkey, chicken breasts or wings), seafood, vegetables (e.g., French fries, peppers), convenience or snack foods (e.g., burritos), pizza, breads, cookies, and pastries. It should be understood to one having ordinary skill in the art that foodstuff can comprise any variations of the above-mentioned food items marinated or lathered in oil or other substances.

Reverse searing is a two-step cooking technique that involves cooking a foodstuff slowly at a low temperature in the first step, and then searing it at a high temperature for a short period of time at the end of the cooking process in the second step. The result is a piece of foodstuff that is evenly cooked throughout and has a delicious, caramelized sear on the outside. However, the problem with the conventional reverse sear method of cooking foodstuff is that a user needs to take out the food from the oven and check the food item with a thermometer to measure the internal temperature while it is being slowly cooked at the first step. It is not easy for a person cooking the food to understand exactly when to stop the slow cook and start searing the food so that it is not overcooked. The foodstuff may not develop a proper sear or crust if the initial low temperature cooking is not done evenly or accurately. Foodstuff may be overcooked if the internal temperature reaches the critical temperature before foodstuff goes into the fast cooking or searing stage. Additionally, convection based methods heat the foodstuff from outside using high temperatures until the foodstuff is cooked from the inside. This may cause the juices in the foodstuff to evaporate and the foodstuff to become dry. So, it is important to monitor the cooking process closely and to adjust the temperature and cooking time as needed to ensure that the foodstuff is cooked to the desired level of doneness, i.e. juicy on the inside and crispy on the outside.

In some embodiments of the invention, the first cooking method can be any of the suitable methods but not limited to pressure cooking, roasting, baking, or sous vide. In a preferred embodiment, the first step cooking can be pressure steam cooking. Steam cooking and/or pressurized steam cooking can reduce the evaporation of juices from the foodstuff and also allow fast cooking at a lower temperatures due to higher conductivity of the steam. In some embodiments of the invention, the next step of reverse searing process can be any of the suitable methods but not limited to pan searing, grill searing, broiler searing or convection for cooking (searing) the foodstuff at very high temperature and to create a caramelized crust on the outside. In a preferred embodiment of the present invention, the second cooking method is convection based searing method using hot air to cook the foodstuff from the outside. In another embodiment, the second cooking method may use infra-red lamp to sear the foodstuff. The searing can be performed lesser amount of time to avoid overcooking the food.

In some embodiments of the invention, more than two stages and more than two cooking methods can be used for cooking the foodstuff in the oven. It should also be understood that the multiple cooking steps can be performed in any suitable order without deviating from the scope of the proposed invention. In some embodiments of the invention, the first cooking method can be searing of the foodstuff and the second cooking method can be slow steam cooking of the foodstuff. In this case, the time and parameters of the searing step can be adjusted based on the time and parameters of the slow cooking step so that the critical temperature of the foodstuff is reached after the second stage slow cooking.

The critical temperature for a food item refers to the temperature at which the food is considered to be cooked or safe to eat. The critical temperature for a food item depends on the type of food and the desired level of doneness. For example, the critical temperature for meat, such as chicken or beef, is typically around 165 degrees Fahrenheit (74 degrees Celsius). At this temperature, the meat is considered to be fully cooked and safe to eat. The critical temperature for other types of food, such as vegetables, grains, and fish, may be different.

In a preferred embodiment of the invention, the method automatically identifies the time of the first step slow cooking and the time of the second stage fast cooking based on one or more of the type, size, temperature, and one or more parameters such as height or depth derived from 3D image of the foodstuff. The slow cook is stopped before the foodstuff reaches the critical temperature by an amount determined by various parameters. Next, the fast cook of searing is started. In preferred embodiments of the invention, the slow cook method can be a pressurized steam cooking method. In alternate embodiments, any suitable methods mentioned supra can be used for slow cooking step. In a preferred embodiment of the invention, the method automatically reduces the time of the slow cooking so that the internal temperature of the food does not prematurely reach the critical temperature. In this way, the method avoids overcooking the food during the fast cooking searing step.

A 3D measurement system, including but not limited to a 3D camera, in the cooking apparatus is configured to capture images of the foodstuff in the cooking apparatus. The processor is configured to process the images captured by the 3D measurement system to generate a 3D profile of the food item. The 3D profile is a three-dimensional representation of the foodstuff that shows the relative distance of the different parts of the foodstuff from the camera. The 3D profile of the foodstuff can be used to determine the point in the foodstuff that will take the longest amount of time to cook. The 3D measurement system may be mounted on the oven or maybe a handheld device. The 3D measurement system may use a variety of techniques, such as laser scanning, structured light, or time-of-flight measurement, to generate the 3D profile. The 3D measurement system may use any suitable method known in the art for capturing an image of the foodstuff and/or generating a 3D profile of the foodstuff. The 3D profile may be used to visualize the internal structure of the food item and to monitor the cooking process. In one embodiment, the 3D measurement system is integrated into an oven. The user may place the food item in the oven, and the 3D measurement system will automatically capture images of the foodstuff and generate a 3D profile. In another embodiment, the 3D measurement system is a handheld device operated by a user, and the user can capture an image of the foodstuff using the 3D measurement system before placing the foodstuff in the oven. In a preferred embodiment of the invention, the 3D measurement system captures an image of the foodstuff before the cooking process is started. In another embodiment, the 3D profile of the foodstuff is generated before the cooking process is started.

According to another embodiment of the invention, the 3D profile of the foodstuff can be generated using two or more 2D cameras. In some embodiments, the two or more 2D cameras can be placed inside the cooking chamber in such manner that 2D cameras fully cover the foodstuff being cooked. The two or more 2D cameras can observe the food from multiple angles and determine category, appearance, and status of the foodstuff being cooked. The two or more 2D cameras capture a plurality of images of the foodstuff at different viewing angles. In some embodiments, one or more 2D cameras can be installed on the door of the cooking apparatus. In some embodiments, one or more 2D cameras can be installed inside the cooking chamber of the cooking apparatus. According to a preferred embodiment of the invention, any suitable algorithm can be used to create 3D image of the foodstuff by combining multiple 2D images from the different 2D cameras installed at various positions in the cooking apparatus. In some embodiments of the invention, the algorithm can match feature among images, triangulate relative positions of the features of the images and construct a 3D point cloud and mesh representation of the foodstuff being cooked inside the cooking chamber of the cooking apparatus. In some embodiments of the invention, two or more 2D cameras can be placed at a perpendicular position to each other in such a manner that one or more camera measuring the width of the foodstuff and one or more cameras measuring the height of the foodstuff. According to an example embodiment, one 2D camera can be placed at the ceiling of the cooking apparatus and one or more 2D cameras can be placed at any side walls or door of the cooking apparatus. All 2D cameras should focus towards inside of the cooking camber of the cooking apparatus.

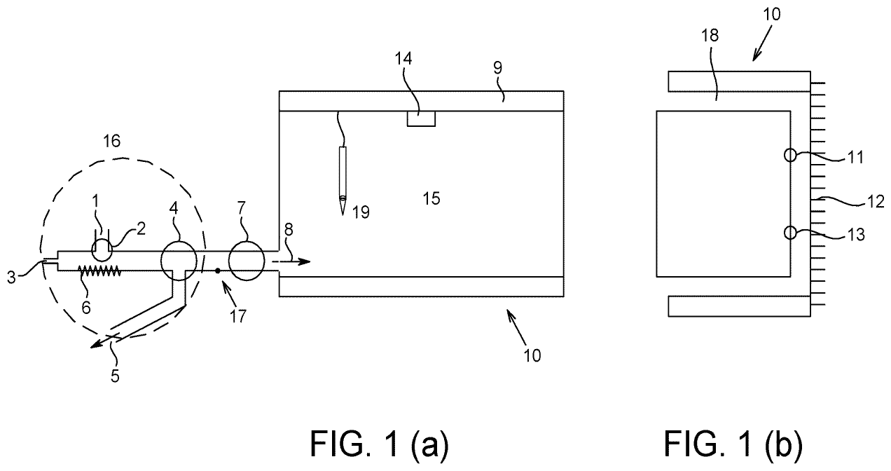

In FIG. 1a there is disclosed a cooking apparatus 10 made in accordance with the present invention. The cooking apparatus 10 comprises a chamber 15 to place the foodstuff to be cooked. According to an embodiment of the invention, pressurized steam or hot air can be injected into the cooking apparatus 10 and the pressure inside the chamber is regulated through an injector means 16. The injector means 16 includes a heating element 6, a water intake means 3 to intake a small amount of water, an air intake pipe 1 to intake air which is controlled by a computer-controlled valve 2, a computer-controlled mixer valve 4, and an inlet 5 for outside air. In a preferred embodiment of the invention, steam is generated outside of the chamber 15 and pumped inside the chamber 15 allowing to inject the steam at different temperatures based on requirements. Even very low temperature steam like moist air can be injected into the chamber.

In the preferred embodiment of the invention, water coming through the water inlet 3 falls on the heating element 6 in a small chamber and generates steam. The steam is then mixed with outside air provided through the air inlet 1 monitored by the computer controlled valve 2. The valve 2 intelligently decides the mixing ratio of steam and outside air to create an appropriate amount of humidity inside the cooking chamber 15 through a humidity control algorithm. The valve 2 can also control the temperature of the steam and air mix by regulating the inlet air through the air inlet means 1. A temperature and humidity sensor 17 regularly measures the temperature and humidity of the steam and provides the readings to the valve 2. In this way, the valve 2 regulates and helps in generating the steam and air mix with an appropriate temperature and humidity. The generated steam is injected into the cooking chamber through an inlet 8 by a pump 7. It should be understood that in some embodiments of the invention, the cooking chamber 15 can comprise a pressure sensor to monitor the pressure inside the chamber and a humidity sensor to monitor the humidity inside the chamber. The pump 7 can pump the steam at specific pressure and regulate the pressure inside the chamber 15 based on feedback provided by a pressure sensor disposed inside the chamber 15 to measure the pressure.

FIG. 1b shows another perspective view of the cooking apparatus 10. When there is too much pressure inside the chamber 15, a computer controlled valve 13 releases the steam and regulates the pressure inside the chamber. In a preferred embodiment of the invention, the valve 13 is provided at the back of the cooking apparatus 10 so that in the event of steam release due to the high pressure inside the chamber or due to any mechanical failure of the valve, the user does not get hurt. When the food stuff is being cooked inside the cooking chamber, it increases the humidity inside the cooking chamber by releasing moisture content into the chamber. In a preferred embodiment of the invention, the pressure and humidity sensors regularly monitor the pressure and humidity inside the chamber to account for the increased humidity from the juices released by the foodstuff being cooked. The humidity control algorithm controls the cooking apparatus and creates the required humidity and pressure inside the cooking chamber 15 by regulating the pump 7 and valve 13. The pump 7 lets more air into the chamber if there is not enough humidity inside the chamber. If the humidity or pressure is too high inside the chamber, the valve 13 releases the pressure.

In a preferred embodiment, the cooking apparatus has a shape of a rectangular box. As shown in FIGS. 1a and 1b, a steam relief area 9 in the form of a gap is provided at the top, bottom and behind the cooking apparatus 10 working as a heat exchanger. Fins 12 are provided on a big plate at the back of the chamber to work as a heat sink, condense the steam and release heat quickly and safely.

The arrangement of the steam relief area 9 allows the released steam to spread in a large area and exhaust at a low temperature. In a preferred embodiment of the invention, an insulation 18 is provided at the top and the bottom of the cooking apparatus 10 to protect the users from burns. This helps the cooking apparatus to release the steam quickly and switch from a first cooking mode to a second cooking mode. In another embodiment of the invention, an additional mechanical safety valve 11 is provided at the back of the cooking chamber. The safety valve 11 decompresses the chamber to reach the normal pressure in the event of pressure reaching above the critical pressure for avoiding any accidents.

In a preferred embodiment, as a foodstuff is placed inside the cooking chamber 15 of the cooking apparatus 10, the pressurized steam is introduced quickly into the cooking chamber through the injector means 16. The pressurized steam is injected into the cooking chamber for a period of time t1 determined by the method to pressure cook the food in the first stage such that appropriate pressure and temperature inside the chamber are attained very quickly. In a preferred embodiment of the invention, the pressure and steam moisture inside the cooking chamber are maintained for the time period t1. The temperature and humidity inside the cooking chamber is controlled by the temperature and humidity sensors provided inside the cooking chamber. The internal temperature of the food can be measured by any suitable temperature measuring device including but not limited to a thermometer or an infrared camera. The method stops the first stage cooking before the internal temperature reaches the critical temperature. The first stage cooking under pressure significantly reduces the overall cooking time. Before transitioning into the second stage of cooking i.e. searing, the pressure inside the cooking chamber should be released. The pump 7 blows the hot air inside the cooking chamber, pushing all the steam out through the mechanical valve 13. The valve 13 allows the steam to release very quickly and safely through the steam relief area provided at the back side of the cooking chamber.

In a preferred embodiment of the invention, the cooking apparatus 10 includes a thermometer 19 to continuously measure the temperature of the foodstuff cooking in the cooking chamber. The thermometer 19 can provide dynamic feedback to adjust temperature and pressure inside the cooking chamber in real-time. In some embodiments of the invention, the thermometer 19 can be adapted to be inserted into the foodstuff to be cooked by the cooking apparatus 10.

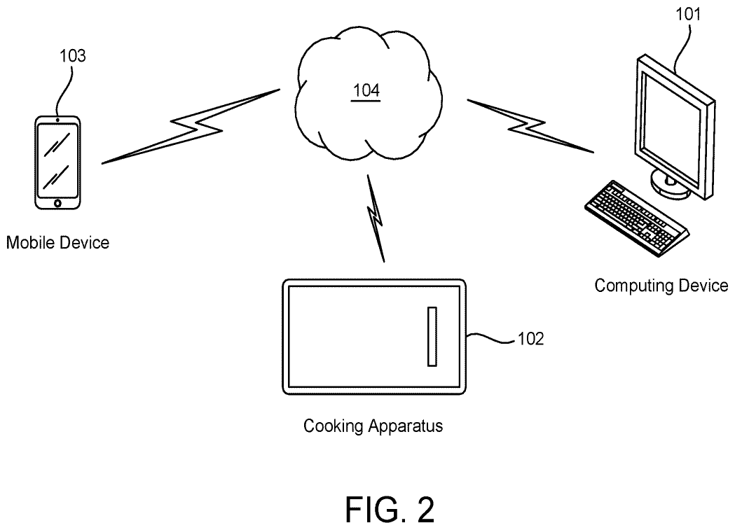

FIG. 2 is a networked system of a cooking apparatus, in accordance with various embodiments. A computing device 101 can store the food profiles of the foodstuff. The computing device 101 can be accessed via a wide area network (WAN) 104, such as the Internet. A cooking apparatus 102 can establish a network connection to the computing device 101. In some embodiments, a mobile device 103 can be connected to the cooking appliance 10 via a local area network or a peer-to-peer connection (e.g., Bluetooth) or an ad-hoc network. In some embodiments, the connection to the cooking apparatus 102 can be established by an access point, a router, the mobile device 103, or other network equipment known to a person of ordinary skilled in the art. It should also be noted that the system shown in FIG. 4, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

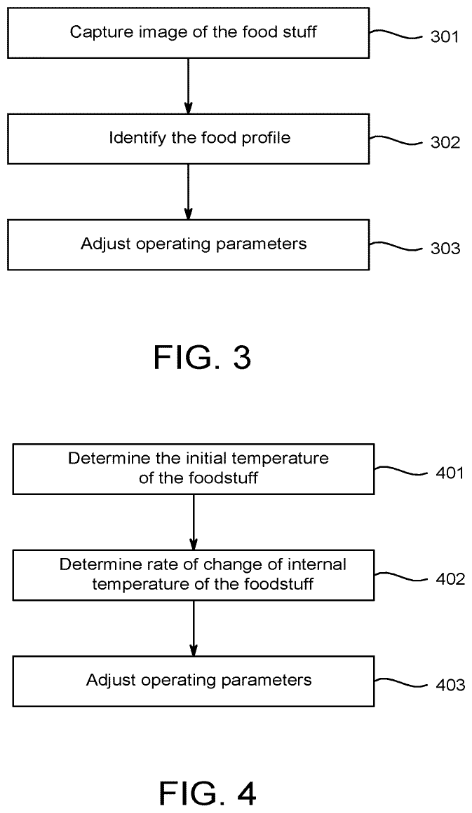

FIG. 3 is a flowchart illustrating a method of cooking a foodstuff in the cooking apparatus 10 in accordance with various embodiments of the invention. At step 301, an image of the foodstuff is captured by an imaging device. In an embodiment of the invention, the imaging device is a 3d measurement system. In some embodiments, the imaging device can be any suitable imaging device, including but not limited to, a mobile phone, tablet computer, a 2D camera, a 3D camera, LIDAR, etc. A 3d profile or dimension profile of the foodstuff is created by a program running on any computing device, including but not limited to the imaging device, the computing device 101, cooking apparatus 10 or 102, or any other device capable of computing. The dimensions of the foodstuff to be cooked are determined from the captured image or the 3D profile of the foodstuff.

At step 302, a food profile of the foodstuff is identified from a database at the computing device. Based on the food profile of the foodstuff, initial operating parameters of the cooking apparatus 10 for cooking the foodstuff are determined.

At step 303, operating parameters for a first cooking mode and for a second cooking mode of the cooking apparatus 10 can be adjusted. In some embodiments of the invention, the first cooking mode can be slow cooking, pressure cooking with steam or pressure cooking with hot air etc. In some embodiments of the invention, the second cooking mode can be fast cooking, searing, convection etc. In some embodiments, the operating parameters can be cooking time, power, cooking temperature, or pressure inside the cooking chamber etc.

In the primary embodiment of the invention, the time of the first (slow) cooking period is reduced based on 3D profile of the foodstuff, the time of the searing in the second cooking period and the parameters of the searing in the second cooking period. In another embodiment of the invention, the initial temperature of the foodstuff can also be used in addition to the 3D profile of the foodstuff, the time and the searing parameters to calculate the time of the first (slow) cooking period. The initial temperature of the foodstuff can be determined using various methods, including but not limited to, an infrared sensor placed inside or outside the cooking chamber of the cooking apparatus, a thermometer placed inside or outside the cooking chamber of the cooking apparatus, 3D profile of the foodstuff, input by a user using an appropriate input means etc. The camera and sensors inside or outside the cooking chamber can identify the type of foodstuff, size of the foodstuff and initial temperature of the foodstuff. The method calculates the total cooking period such that internal temperature reaches the critical temperature based on 3D profile of the foodstuff, size of the foodstuff, and initial temperature of the foodstuff. In a preferred embodiment of the invention, the 3D profile of the foodstuff can be one or more parameters derived from the 3D image of the foodstuff.

FIG. 4 is a flowchart illustrating a method of cooking a foodstuff in the cooking apparatus 10 in accordance with an alternate embodiment of the invention. At step 401, an initial temperature of the foodstuff is determined by a temperature measuring device, a thermometer 19 for example. In an embodiment of the invention, a user can insert the thermometer 19 into the foodstuff after putting the foodstuff in the cooking chamber for cooking. In some embodiments, the temperature measuring device can be attached permanently to the cooking chamber. In some embodiments, the temperature measuring device can be a removable component that conveniently detaches and/or re-attaches to the cooking apparatus 10 or one or more parts of the cooking apparatus. In some embodiments, the temperature measuring device can be a single point thermometer measuring the internal temperature of the foodstuff. In some embodiments, the temperature measuring device can be a multipoint thermometer measuring the temperature at multiple points inside the foodstuff. The thermometer 19 continuously measures the internal temperature of the foodstuff being cooked and sends the measured temperature reading to the controlling algorithm to adjust the cooking time of one or more cooking modes of the cooking apparatus 10.

At step 402, based on the continuous reading of the internal temperature of the foodstuff, a rate of change of the internal temperature can be determined. The rate of change of internal temperature of the foodstuff can help in predicting the time for the foodstuff to reach the critical temperature. Additionally, the initial temperature of the foodstuff and rate of change of internal temperature of the foodstuff can predict the searing time for the foodstuff in the second cooking mode.

At step 403, based on the rate of change of the internal temperature of the foodstuff, the operating parameters for a first cooking mode of the cooking apparatus 10 can be predicted. In some embodiments of the invention, the operating parameters for a second cooking mode of the cooking apparatus 10 can be predicted. In some embodiments of the invention, the first cooking mode can be slow cooking, pressure cooking with steam or pressure cooking with hot air etc. In some embodiments of the invention, the second cooking mode can be fast cooking, searing, convection etc. In some embodiments, the operating parameters can be cooking time, power, cooking temperature, or pressure inside the cooking chamber etc.

In an embodiment of the invention, the rate of change of the internal temperature of the foodstuff can be used to predict the change in parameters of the first cook period. The rate of change of the internal temperature of the foodstuff can be calculated from the reading received from the thermometer. The method can estimate an updated time for cooking the foodstuff in the first stage based on the rate of change of the internal temperature of the foodstuff during the first cook period. The method can further predict the amount of time to be reduced for cooking the foodstuff in the first stage based on the rate of increase in the internal temperature of the foodstuff while cooking. In some embodiments of the invention, at least one of the cooking periods should be changed such that the critical temperature is not reached before the cooking is complete. In some embodiments of the invention, the cooking mode of the cooking apparatus is changed from the first cooking mode to the second cooking mode such that the internal temperature of the foodstuff reaches the critical temperature only after the cooking process is complete. The changing of the cooking modes is performed seamlessly such that the cooking apparatus provides perfectly cooked food after the completion of the cooking process. In some embodiments, the time of the first (slow) cooking period is reduced based on the rate of change of the internal temperature of the foodstuff, the time of the searing in the second cooking period and the parameters of the searing in the second cooking period. In another embodiment of the invention, the initial temperature of the foodstuff can also be used in addition to the 3D profile of the foodstuff, the time and the searing parameters to calculate the time of the first (slow) cooking period. The initial temperature of the foodstuff can be determined using various methods, including but not limited to, an infrared sensor placed inside or outside the cooking chamber of the cooking apparatus, a thermometer placed inside or outside the cooking chamber of the cooking apparatus, input by a user using an appropriate input means etc. The camera and sensors inside or outside the cooking chamber can identify the type of foodstuff, size of the foodstuff and initial temperature of the foodstuff. The method calculates the total cooking period such that internal temperature reaches the critical temperature based on the rate of change of the internal temperature of the foodstuff, size of the foodstuff, and initial temperature of the foodstuff.

In another embodiment of the invention, another cooking period can be introduced prior to the first cooking period in a condition when the initial temperature of the foodstuff is below a certain threshold. The initial temperature of the foodstuff can be determined using various methods, including but not limited to, an infrared sensor placed inside or outside the cooking chamber of the cooking apparatus, a thermometer placed inside or outside the cooking chamber of the cooking apparatus, 3D profile of the foodstuff etc. When the initial temperature of the foodstuff is below a certain threshold, for example, cooking a foodstuff straight from the freezer, the method activates a defrosting mode in the cooking apparatus. In some embodiments of the invention, in the defrosting mode, pressurized steam at a low temperature can be used for a certain period of time. The cooking apparatus operates in the defrosting mode till the temperature of the foodstuff reaches a critical defrost temperature suitable to start the slow cooking of the foodstuff. The duration of the defrosting mode depends on the initial temperature of the foodstuff, the size of the foodstuff and the 3D profile of the foodstuff. Based on the duration of the defrosting mode, the method can calculate temperature during the defrosting mode, pressure during the defrosting mode, and the percentage of moisture in the air during the defrosting mode. In another embodiment of the invention, the method can optimize the parameters such as temperature, pressure, and the percentage of moisture in the air during the defrosting mode to determine the optimal defrosting time for the foodstuff to reach the defrost critical temperature prior to the first (slow) cooking period.

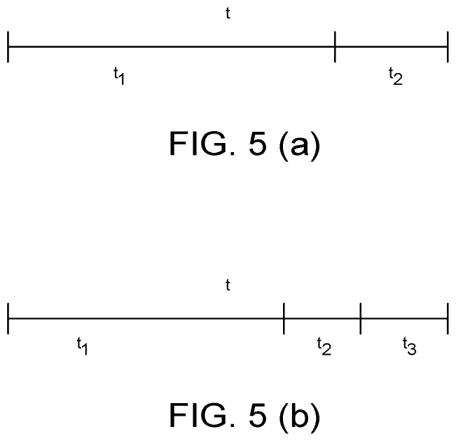

FIG. 5a shows a timing diagram of cooking a foodstuff in a cooking apparatus 10 according to the preferred embodiment of the invention. A time period ‘t’ may represent the time to cook the foodstuff. In a preferred embodiment of the invention, ‘t’ represents the time taken to cook the foodstuff such that the center of the foodstuff reaches its critical temperature. In other embodiments, the time ‘t’ represents the time for other portions of the foodstuff to reach the critical temperature. In a primary embodiment of the invention, the time ‘t’ can be calculated by modeling one or more parameters of the foodstuff such as initial temperature of the foodstuff, the rate of change of the internal temperature of the foodstuff while cooking, type of the foodstuff, conductivity of the foodstuff, and 3D shape of the foodstuff or at least one of the parameters such as depth of the foodstuff derived from the 3D shape of the foodstuff measured in any suitable method known in the art. In an alternate embodiment of the invention, the time ‘t’ can be determined by extrapolating the time ‘t’ through previously recorded readings in a table or database. The table or database stores readings of time ‘t’ calculated through experimentation on various sizes and types of foodstuffs, conductivity of the foodstuff, food profile of the foodstuff, initial temperature of the foodstuff and sear parameters. In another embodiment of the invention, a user can provide sear parameters and the critical temperature through any suitable input means which can further affect the temperature during the first cooking period, pressure during the first cooking period and cooking time of the first cooking period.

In preferred embodiments of the invention, the method for cooking the foodstuff in the cooking apparatus 10 divides the cooking period ‘t’ into at least two portions. A first cooking time ‘t1’ represents the time that the foodstuff is cooked in the first cooking mode by a first cooking process (for example, a slow and/or low temperature cooking mode using steam and/or pressurized steam) and a second cooking time ‘t2’ represents the time that the foodstuff is cooked in the second cooking mode by a second cooking process (for example, searing the foodstuff at a high temperature). The method of cooking the foodstuff in the cooking apparatus 10 calculates, adjusts and/or reduces the times t1 and t2 based on a variety of factors. The times t1 and t2 can be calculated, adjusted and/or reduced by the method such that the foodstuff reaches its critical temperature on or after the end of second cooking process. In a preferred embodiment, the duration t1 can be calculated, adjusted and/or reduced by the method based on one or more of the 3d profile of the foodstuff, the rate of change of the internal temperature of the foodstuff while cooking, the type of the foodstuff, conductivity of the foodstuff, the distance of the center of foodstuff from its outer surface, the time t2 of the second cooking mode, the cooking method used in the second cooking mode and/or an expected increase in temperature of the foodstuff in the second cooking mode. In alternate embodiments, the method may calculate, adjust and/or reduce the pressure and/or temperature of the first cooking process in addition to the cooking time t1 based on one or more of the 3d profile of the foodstuff, the rate of change of the internal temperature of the foodstuff while cooking, the type of the foodstuff, conductivity of the foodstuff, the distance of the center of foodstuff from its outer surface, the time t2 of the second cooking mode, the cooking method used in the second cooking mode and/or an expected increase in temperature of the foodstuff in the second cooking mode. In other embodiments any combination of the cooking time t1, temperature or pressure of the first cooking process can be calculated by the method based on one or more of the 3d profile of the foodstuff, the rate of change of the internal temperature of the foodstuff while cooking, the type of the foodstuff, conductivity of the foodstuff, the distance of the center of foodstuff from its outer surface, the time t2 of the second cooking mode, the cooking method used in the second cooking mode and/or an expected increase in temperature of the foodstuff in the second cooking mode. The system can also determine the time ‘t1’ using the sear parameter such as sear temperature, sear time and pressure during the searing process. The searing parameters can also be used to determine the temperature during the first cooking period, pressure during the first cooking period and cooking time of the first cooking period such that the foodstuff reaches its critical temperature after the end of the second cooking period t2. In certain embodiments, 3d profile of the foodstuff, the type of foodstuff, conductivity of the foodstuff and/or distance of the center of the foodstuff from its outer surface can be determined from an image of the foodstuff captured by the imaging system. The first cooking mode can be any suitable slow cooking method, including but not limited to pressure cooking, roasting, baking, or sous vide. In a preferred embodiment, the first cooking mode can be steam cooking and/or pressurized steam cooking. Steam cooking and/or pressurized steam cooking can reduce the evaporation of juices from the foodstuff and also allow fast cooking at a lower temperatures due to higher conductivity. The method may use any suitable means, including but not limited to a thermometer for measuring the inner temperature of the foodstuff during the cooking process.

In preferred embodiments of the invention, the method intelligently calculates, adjusts and/or reduces the time t1 of the slow cook mode such that internal temperature of the foodstuff does not reach the critical temperature in the slow cook stage. The internal temperature of the foodstuff being cooked is continuously measured by a thermometer inserted into the foodstuff. The rate of change of the internal temperature of the foodstuff being cooked can be calculated based on internal temperature readings received from the thermometer. The method can predict the time to stop the cooking of foodstuff in first mode (slow cooking) based on determined rate of change of the internal temperature of the foodstuff being cooked. The cooking mode of the cooking apparatus is changed to the second cooking mode for a time t2 such that internal temperature of the foodstuff reaches the critical temperature after the end of the time t2 and provides perfectly cooked food. The time t2 can also be determined by the rate of change of the internal temperature of the foodstuff.

Usually, cooked food is not consumed right after it is taken out of the cooking apparatus and continues to cook after the cooking method by the cooking apparatus ends. This additional cooking may make the foodstuff overcooked when it is consumed. In accordance with additional embodiments of the present invention, the method for cooking the foodstuff in the cooking apparatus 10 divides the cooking period ‘t’ into three portions. A first cooking time ‘t1’ represents the time that the foodstuff is cooked in the first cooking mode by a first cooking process (for example, a slow and/or low temperature cooking mode using steam and/or pressurized steam) and a second cooking time ‘t2’ represents the time that the foodstuff is cooked in the second cooking mode by a second cooking process (for example, searing the foodstuff at a high temperature). A third time ‘t3 represents the time between the end of second cooking process and the expected time when a user will start consuming the cooked foodstuff. In certain embodiments, a user can input the time t3 in the cooking system using any suitable input means including, but not limited to, an application on the user's mobile device, input means provided on the cooking apparatus etc. In a preferred embodiment of the invention, as shown in time diagram in FIG. 5b, the method calculates, adjusts and/or reduces the time t1 based on the time t3 and one or more of the 3d profile of the foodstuff, rate of change of the internal temperature of the foodstuff, the type of the foodstuff, conductivity of the foodstuff, the distance of the center of foodstuff from its outer surface, the time t2 of the second cooking mode, the cooking method used in the second cooking mode and/or an expected increase in temperature of the foodstuff in the second cooking mode. In an alternate embodiment, t2 or the length of time for cooking the foodstuff in the second cooking mode may be adjusted by the user manually based on preference. The user may use any input means including, but not limited to, an application on the user's mobile device, input means provided on the cooking apparatus etc. to specify the time t2.

In an alternate embodiment, a camera inside the cooking apparatus 10 can identify the foodstuff like beef, chicken, fish etc. placed inside the cooking chamber 15. The cooking apparatus can download the properties of the foodstuff from a database available at the computing device, user mobile device etc. Based on the properties of the foodstuff, the cooking apparatus determines the first portion of the time of cook and reduce that time such that when the sear happens in the next stage of cooking, the critical temperature is achieved but not exceeded and foodstuff is not overcooked. A 3D profile of the foodstuff can be created using a 3D scanning means provided inside or outside of the cooking apparatus in various embodiments of the inventions. In another embodiment of the invention, 3D profile of the foodstuff can be created based on an image taken by the user of the foodstuff before putting the foodstuff into the cooking chamber.

In another embodiment of the invention, the camera inside the cooking apparatus determines the identity of the foodstuff and further determines the conductivity of the foodstuff. A temperature measuring means can be provided for measuring the temperature at various points on the foodstuff inside the cooking chamber 15. Based on 3D profile, conductivity, and temperature information, the method determines the time to reach the critical temperature for the foodstuff and cook perfectly. The method divides the cooking time into at least two cooking stages, stops the first stage of cooking before the foodstuff reaches its critical temperature, and starts the second stage of cooking so that foodstuff is cooking while searing in the second cooking mode. In an alternate embodiment, a user can specify, using any suitable means, a type of sear desired on the cooked foodstuff. The type of sear may include temperature of the second cooking/searing mode or a duration t2 of the second cooking/searing mode. In this embodiment, the method may calculate, adjust and/or reduce the time t1 based on the type of sear input by the user, the temperature and/or duration of the second cooking/searing mode and optionally one or more of the 3d profile of the foodstuff, rate of change of the internal temperature of the foodstuff, the type of the foodstuff, conductivity of the foodstuff, the distance of the center of foodstuff from its outer surface, the cooking method used in the second cooking mode and/or an expected increase in temperature of the foodstuff in the second cooking mode. In another embodiment, the user may specify a degree of doneness desired for the cooked foodstuff. The primary way of specifying the degree of doneness for the foodstuff is to change the critical temperature through an input means. For example, the user may specify whether the cooked foodstuff should be rare, medium rare or well done. The user may use any suitable means to input the level of doneness, including but not limited to an application on a mobile device, an input panel on the cooking apparatus etc. In certain embodiments, method may calculate or determine the critical temperature of the foodstuff based on the specified level of doneness. The method may also calculate or determine the time ‘t’ required to cook the foodstuff based on the desired level of doneness. In some embodiments, the method may calculate, identify or determine the time t and/or the critical temperature for the foodstuff using a database, for example a remote database, storing properties of different foodstuff.

The method specifically identifies the impact of sear on the foodstuff and hence determines the time and temperature for the slow cook as well as sear. It should be understood that the time of the slow cook will always be less than the time for the foodstuff to reach the critical temperature. In the preferred embodiment of the invention, the method can take all inputs from the user and from the various sensors of the cooking apparatus and provide as input to an algorithmic formula to determine the times and temperature for slow cook and searing. In some embodiments of the invention, the method can be implemented in the form of an algorithm. In some embodiments of the invention, the formula can be a table of readings through experimentation or one or more scientific equations.

In some embodiments of the invention, a user can change the amount of sear through an application installed on their mobile device. The user can also change the temperature and duration of the sear to the desired crisp level. In other embodiments, the user can select the predefined settings from the application. Based on user selection, the method can change (increase or decrease) the amount of time for steam cooking and searing.

In the preferred embodiments of the invention, the first stage cooking method can be pressure cooking the foodstuff at a low temperature and the second stage cooking method can be searing the foodstuff at a high temperature. Cooking the foodstuff in the first stage at a low temperature for a longer period of time may overheat the cooking apparatus which may eventually overcook the food while searing in the second stage. To cool down the cooking apparatus after the first stage of cooking, air, preferably cold air, can be introduced in the cooking apparatus between the first stage cooking and the second stage cooking. It should be understood that the transition of the cooking apparatus from the first stage low temperature cooking to the second stage high temperature cooking may take some time. To stop cooking the foodstuff for this period of time, in one embodiment, non-moving cold air can be introduced into the cooking chamber of the cooking apparatus, forming an envelope around the foodstuff. In another embodiment, cold air can be continuously injected into the cooking chamber while the cooking apparatus heats up for the second stage of cooking. When the cooking apparatus reaches the required temperature for searing, the cold air injection can be stopped, and one or more fans of the cooking apparatus can be started causing the air to become turbulent and perform searing of the foodstuff inside the cooking chamber.

In some embodiments of the invention, for reducing the overall cooking time, the cooking chamber can be heated and prepared for the second stage of cooking while the cooking apparatus is being operated in the first stage of cooking. In an example embodiment, cold or room temperature air can be injected into the cooking chamber without circulation while the foodstuff is cooking in the first stage. In another example embodiment, cold air can be continuously pumped into the cooking chamber while the foodstuff is cooking in the first stage. Once the cooking chamber is hot enough for the high temperature searing, the cold air can be stopped from being introduced into the cooking chamber. Further, one or more fans can be started causing the air to become turbulent and perform searing of the foodstuff inside the cooking chamber.

According to another embodiment of the invention, the overall cooking time can also be reduced by using an inner metal vessel, for example made from thin steel, inside the main cooking chamber 15. The cooking chamber 15 of the cooking apparatus can be designed in a way that the inner metal vessel can be provided inside the cooking chamber 15. A layer of insulation can be filled between the inner metal vessel and the cooking chamber. In a preferred embodiment of the invention, the insulation between the cooking chamber 15 and the inner metal vessel can be made with a strong material that can withstand the pressure of the steam inside the cooking apparatus. Since the inner metal vessel is made with very thin steel, it heats up quickly and gets prepared for second stage searing. One of the primary advantages of this embodiment of the invention is that the preheating of the oven can be avoided. Further, the inner metal vessel heating up quickly reduces the chances of overcooking the foodstuff at the second stage searing. In an example embodiment, the inner metal vessel can be made with a quarter mm thick steel and outer or main cooking chamber can be made with 3 mm thick steel. In the preferred embodiments, the outer chamber provides structural elements to the cooking apparatus so that it can hold the pressure or force of the steam inside the oven against the inner vessel. Therefore, the outer chamber provides the structure to the cooking apparatus and inner vessel provides quick heating capabilities.

In an alternate embodiment of the invention, the cooking apparatus can also have a pot to contain any suitable flavoring spices such as clove, basil, etc. The steam generated by the steam generating means can travel through the flavoring pot. In another embodiment, the water for generating the steam can travel through the flavoring pot to generate the flavored steam. When flavored steam is injected into the cooking chamber, the steam circulates around the foodstuff. With this method of steam marinating, foodstuff can be infused with a particular flavor of user choice.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed. Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A cooking method, comprising:
receiving a food item in a cooking chamber of a cooking apparatus;
capturing an image of said food item;
determining at least one of a type of said food item and a 3D parameter of said food item;
cooking said food item for at least two cooking periods; wherein the cooking periods can happen in any chronological order, and
adjusting a parameter of one of the cooking periods based on at least one of the 3D parameters of the said food item, type of said food item, and a cooking parameter of at least one other cooking period.

2. The method of claim 1 wherein, the parameter of a first cooking period is at least one of cooking temperature, duration or pressure of the first cooking period.

3. The method of claim 1 wherein, the parameter of a second cooking period is at least one of temperature or duration of the second cooking period.

4. The method of claim 1, wherein the first cooking period uses steam to cook the food item.

5. The method of claim 1, wherein the first cooking period uses pressurized steam to cook the food item.

6. The method of claim 1, wherein the second cooking period uses hot air circulating in a turbulent fashion inside the cooking chamber to cook the food item.

7. The method of claim 1, wherein the parameter of the first cooking period is adjusted such that the food item's internal temperature does not reach a critical temperature in the first cooking period.

8. The method of claim 1, wherein the parameter of the first cooking period is adjusted based on a period of time between end of the second cooking period and a time of consumption of the food item.

9. A cooking method, comprising:
receiving a food item in a cooking chamber of a cooking apparatus;
cooking said food item for at least two cooking periods wherein, the cooking period can happen in any chronological order;
determining a rate of change of internal temperature of the food item in one of the cooking periods; and
adjusting a parameter of one of the cooking period based on one or more of the rate of change of internal temperature of the food item in the first cook period and a cooking parameter of at least one other cooking period.

10. The method of claim 9 wherein, the parameter of a first cooking period can be adjusted by controlling one or more heating elements of the cooking apparatus based on the rate of change of internal temperature of the food item.

11. The method of claim 9 wherein, the rate of change of internal temperature is determined by temperature data received from a thermometer.

12. The method of claim 9 wherein, the parameter of the first cooking period is at least one of cooking temperature, duration or pressure of the first cooking period.

13. The method of claim 9 wherein, the parameter of the second cooking period is at least one of temperature or duration of the second cooking period.

14. The method of claim 9, wherein the first cooking period can use steam to cook the food item.

15. The method of claim 9, wherein the first cooking period can use pressurized steam to cook the food item.

16. The method of claim 9, wherein a second cooking period can use hot air circulating in a turbulent fashion inside the cooking chamber to cook the food item.

17. A cooking method for cooking a food item in a cooking apparatus, comprising:
determining an initial temperature of the food item;
determining if the initial temperature of the food item is below a threshold temperature;
initiating a defrost mode in the cooking apparatus for a defrost period until the food item reaches the threshold temperature; and
initiating a first cooking mode for a first cooking period when the food item reaches the threshold temperature.

18. The method of claim 17 wherein the first cooking period is initiated if the initial temperature of the food item is equal to or more than the threshold temperature.

19. A cooking apparatus comprising:
an inner vessel; and
an outer chamber providing the structure to the cooking apparatus;
wherein the inner vessel is provided inside the outer chamber,
wherein the inner vessel is made with very thin metal such that the inner vessel can heat up or cool down quickly between different stages of cooking or at beginning of a cooking period.

20. A cooking method, comprising:
receiving a food item in a cooking chamber of a cooking apparatus;
capturing an image of said food item;
determining at least one of a type of said food item and a 3D parameter of said food item;
cooking said food item for at least a first cooking period and a second cooking period, wherein, the first cooking period is a low temperature cooking period and the second cooking period is a high temperature cooking period; and
adjusting a parameter of the first cooking period based on at least one of the 3D parameter of the said food item, type of said food item, and a cooking parameter of the second cooking period.
